(19) United States
(12) Patent Application Publication
(10) Pub. No.: US 2026/0119886 A1
(43) Pub. Date: Apr. 30, 2026

(54) METHOD OF TRAINING SUPERVISED DIFFUSION MODEL FOR SAMPLING, DEVICE THEREOF AND MEDIUM

(71) Applicants: Hangzhou Dianzi University, Hangzhou City (CN); Harbin Institute of Technology, Harbin City (CN)

(72) Inventors: Chen YE, Hangzhou City (CN); Hengtong ZHANG, Harbin City (CN); Hua ZHANG, Hangzhou City (CN); Guojun DAI, Hangzhou City (CN)

(21) Appl. No.: 18/980,909

(22) Filed: Dec. 13, 2024

(30) Foreign Application Priority Data
Oct. 25, 2024 (CN) 202411506434.9

(51) Int. Cl. G06N 3/09

(52) U.S. Cl. CPC G06N 3/09

(57) ABSTRACT

Provided is a method of training a supervised diffusion model for sampling, a device thereof and a medium, which relates to the field of data processing. The method includes: acquiring a supervised initial diffusion model, and adding control layers to the initial diffusion model to obtain a diffusion model; using a training set to train the diffusion model until the diffusion model after training meets a preset condition to obtain the trained diffusion model; deploying the trained diffusion model at a user terminal, using the user terminal to optimize the trained diffusion model to obtain the supervised diffusion model, and using the supervised diffusion model for sampling to obtain a sampling result. The method can prevent the diffusion model from generating harmful samples in an intermediate process.

### CROSS-REFERENCE TO RELATED PRESENT DISCLOSURE

This patent application claims the benefit and priority of Chinese Patent Present disclosure No. 2024115064349 filed with the China National Intellectual Property Administration on Oct. 25, 2024, the disclosure of which is incorporated by reference herein in its entirety as part of the application.

### TECHNICAL FIELD

The present disclosure relates to the field of data processing, in particular to a method of training a supervised diffusion model for sampling, a device thereof and a medium.

### BACKGROUND

In recent years, diffusion models have become a mainstream image generation technology. These diffusion models can be used to generate a large number of colorful, vivid and diverse pictures. However, the problems brought in the same period are how to prevent the diffusion models from being trained to produce harmful samples and how to prevent the diffusion models from being influenced by harmful training samples.

At present, the main solution of the above problems is to make a judgment through post-processing, that is, after an image is generated. If the samples are harmful, the samples are not displayed to the end user. The main disadvantage of the solution is that if the model is decompiled by users after distribution and the intermediate results of the diffusion model are obtained, the intermediate results can be directly used for harmful acts. Based on this, how to prevent the diffusion model from generating harmful samples in the intermediate process has become an urgent technical problem in this field.

### SUMMARY

The purpose of the present disclosure is to provide a method of training a supervised diffusion model for sampling, a device thereof and a medium, which can prevent the diffusion model from generating harmful samples in the intermediate process.

In order to achieve the above purpose, the present disclosure provides the following solution.

In a first aspect, the present disclosure provides a method of training a supervised diffusion model for sampling, wherein the method of training the supervised diffusion model for sampling is implemented based on a Regulated Scheme (RSS) framework; the method of training the supervised diffusion model for sampling includes:
acquiring a supervised initial diffusion model, and adding control layers to the initial diffusion model to obtain a diffusion model;
using a training set to train the diffusion model until the diffusion model after training meets a preset condition to obtain a trained diffusion model;
deploying the trained diffusion model at a user terminal, using the user terminal to optimize the trained diffusion model to obtain the supervised diffusion model, and using the supervised diffusion model for sampling to obtain a sampling result.

Preferably, each control layer is added between a convolution layer and a pooling layer of a neural network architecture of the initial diffusion model.

Preferably, an expression of the control layer is:

$${O}_{( l )} := {γ}_{( l )} ⊙ {I}_{( l )} + {β}_{( l )} ;$$

Where, ⊙ is a dot product symbol, O₍ₗ₎ and I₍ₗ₎ are an output and an input of a Regulated (RR) layer, γ₍ₗ₎ and β₍ₗ₎ are two coefficients related to parameters of the diffusion model, γ₍ₗ₎=U_{(γ)}(l,:,:)Ω^{y}(xₜ,pc_{τ})V_{(γ)}(l,:,:), β₍ₗ₎=U_{(β)}(l,:,:)Ω^{y}(xₜ,pc_{τ})V_{(β)}(l,:,:), U_{(γ)}, V_{(γ)}, U_{(β)}, and V_{(β)} are all mapping functions, Ω^{y}(xₜ,pc_{τ}) is an intermediate generation result of step t of the diffusion model, l is an l-th layer of a neural network, xₜ is a matrix, and pc_{τ} is a one-time password generated at a current system time τ.

Preferably, an auto-encoder with only an encoder part reserved is used to determine the intermediate generation result Ω^{y}(xₜ,pc_{τ}) of step t of the diffusion model; where Ω^{y}(xₜ,pc_{τ})=EC(xₜ,pc_{τ},y);
where EC(xₜ,pc_{τ},y) denotes a function of the auto-encoder with only the encoder part reserved, and y is a label of the matrix xₜ.

Preferably, using the training set to train the diffusion model until the diffusion model after training meets the preset condition to obtain the trained diffusion model includes:
initializing parameters of the diffusion model;
taking out samples from the training set, obtaining a sampling step from uniform distribution, obtaining a sampling distribution value from Gaussian distribution, and determining an intermediate result of the current sampling step in the diffusion model;
obtaining a current UNIX timestamp;
determining mapping functions based on the current UNIX timestamp and the intermediate result;
constructing an objective function;
using the objective function to derive the parameters of the diffusion model and the mapping function, iteratively updating the parameters of the diffusion model and the mapping function by a gradient descent method to obtain the diffusion model after training until a change in a value of each dimension on the parameters of the diffusion model after training is less than a set value compared with a previous cycle, and obtaining the trained diffusion model.

Preferably, the objective function is expressed as:

$${min}_{θ} L = 𝔼 [ {𝕀}^{-} ( {x}_{t} ) {‖ ϵ - {\breve{ϵ}}_{θ} ( {x}_{t} , t , {Ω}^{-} ( {x}_{t} , {pc}_{τ} ) ) ‖}^{2} + {𝕀}^{+} ( {x}_{t} ) KL ( {p}_{θ} ( {x}_{t - 1} \vert {x}_{t} , {Ω}^{+} ( {x}_{t} , {pc}_{τ} ) ) ‖ 𝒩 ( 0 , I ) ) ] ;$$

where L is an optimization objective, [symbol] [ ] is a mathematical expectation, [symbol] ⁻(xₜ) and [symbol] ⁺(xₜ) are switching coefficients, ϵ is a sampling distribution value, ϵ̆_{θ}( ) is the diffusion model after training, t is a sampling step, KL is a KL distance, xₜ is a matrix when a sampling step is, pc_{τ} is a one-time password generated at a current system time τ, [symbol] (0,I) is Gaussian distribution, I is an identity matrix, Ω⁻(xₜ,pc_{τ}) and Ω⁺(xₜ,pc_{τ}) are both state matrices related to the intermediate result and the one-time password,

$${p}_{θ} ( {x}_{t - i} \vert {x}_{t} , {Ω}^{+} ( {x}_{t} , {pc}_{τ} ) ) = 𝒩 ( \frac{{x}_{t}}{\sqrt{{α}_{t}}} - \frac{( 1 - {α}_{t} ) {\breve{ϵ}}_{θ} ( {x}_{t} t , {Ω}^{+} ( {x}_{t} , {pc}_{τ} ) )}{\sqrt{{α}_{t} ( 1 - {\overline{α}}_{t} )}} , 1 - {α}_{t} ) ,$$

αₜ is a preset hyper-parameter, α̅ₜ is an intermediate quantity,

$${\overline{α}}_{t} = {\prod }_{s = 1}^{t} {α}_{S} ,$$

αₛ is a hyper-parameter at s, and xₜ₋ᵢ is a matrix when a sampling step is t-i.

Preferably, using the supervised diffusion model for sampling to obtain a sampling result includes:
determining the intermediate result of the supervised diffusion model in the user terminal;
using a classifier at a supervisor terminal to generate a label based on the intermediate result of the supervised diffusion model;
determining whether there is harmful information in the intermediate result of the supervised diffusion model based on the label;
interrupting a training process or a sampling process when it is determined that there is harmful information, so that the final output does not contain harmful information;
iteratively modifying the intermediate result of the supervised diffusion model until an initial value is obtained as the sampling result when it is determined that there is no harmful information.

Preferably, when it is determined that there is no harmful information, a formula

$${\hat{x}}_{t - 1} = \frac{1}{\sqrt{{α}_{t}}} {\hat{x}}_{t} - \frac{( 1 - {α}_{t} ) {ϵ}_{θ} ( {\hat{x}}_{t} , t , {Ω}^{y} ( {\hat{x}}_{t} , {pc}_{τ} ) )}{\sqrt{{α}_{t} ( 1 - {\overline{α}}_{t} )}} + \sqrt{{β}_{t}} ϵ$$

is used to iteratively modify the intermediate result of the supervised diffusion model until the initial value is obtained as the sampling result;

where \hat{x}ₜ₋₁ is a matrix when a sampling step is t-1 in the supervised diffusion model, Ω^{y}(xₜ,pc_{τ}) is an intermediate result of the supervised diffusion model, \hat{x}ₜ is a matrix when the sampling step is t in the supervised diffusion model, Ee the a supervised diffusion model, and βₜ is a coefficient of the supervised diffusion model when a sampling step is t.

In a second aspect, the present disclosure provides a computer device including a memory, a processor and a computer program stored in the memory and executable on the processor, wherein the processor executes the computer program to implement the method of training the supervised diffusion model for sampling provided above.

In a third aspect, the present disclosure provides a non-transitory computer-readable medium, in which a computer program is stored, wherein the computer program, when executed by a processor, implements the method of training the supervised diffusion model for sampling provided above.

According to the specific embodiments provided by the present disclosure, the present disclosure discloses the following technical effects.

The present disclosure provides a method of training a supervised diffusion model for sampling, a device thereof and a medium. Control layers are added to the initial diffusion model by a training process to obtain a diffusion model, and the trained diffusion model is obtained. The trained diffusion model is optimized to obtain the supervised diffusion model. In the process of sampling with the supervised diffusion model, the diffusion model can be prevented from generating harmful samples in an intermediate process, so as to further prevent the diffusion model from being trained to generate harmful samples. In addition, the user terminal is used to train the model and optimize the trained diffusion model, so that the diffusion model can be prevented from being influenced by harmful training samples.

### BRIEF DESCRIPTION OF THE DRAWINGS

In order to explain the technical solution in the embodiments of the present disclosure or in the prior art more clearly, the drawings needed to be used in the embodiments will be briefly introduced hereinafter. Obviously, the drawings described below are only some embodiments of the present disclosure. For those skilled in the field, other drawings can be obtained according to these drawings without paying creative labor.

FIG. 1 is an application environment diagram of a method of training a supervised diffusion model for sampling in an embodiment of the present disclosure.

FIG. 2 is a flow chart of a method of training a supervised diffusion model for sampling according to an embodiment of the present disclosure.

FIG. 3 is a schematic structural diagram of a diffusion model according to an embodiment of the present disclosure.

FIG. 4 is a schematic structural diagram of a computer device according to an embodiment of the present disclosure.

### DETAILED DESCRIPTION OF THE EMBODIMENTS

The technical solutions in the embodiments of the present disclosure will be clearly and completely described with reference to the drawings in the embodiments of the present disclosure hereinafter. Obviously, the described embodiments are only some embodiments of the present disclosure, rather than all of the embodiments. Based on the embodiments in the present disclosure, all other embodiments obtained by those skilled in the field without paying creative labor belong to the scope of protection of the present disclosure.

In order to make the above objects, features and advantages of the present disclosure more obvious and understandable, the present disclosure will be further described in detail with reference to the attached drawings and the detailed implementation hereinafter.

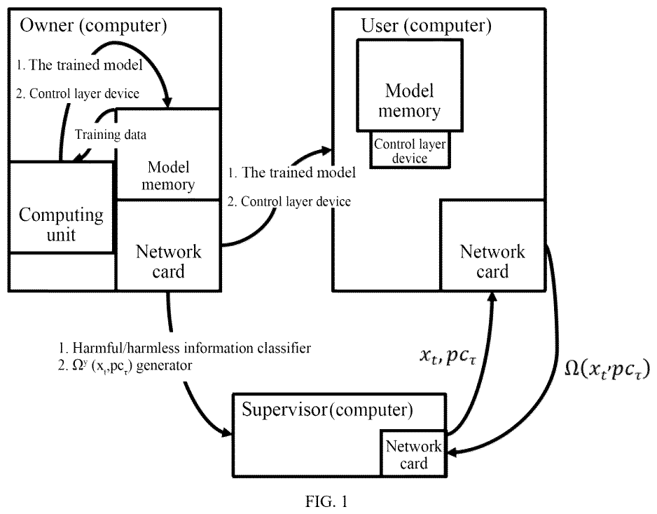

The method of training the supervised diffusion model for sampling according to the embodiments of the present disclosure can be applied to the application environment as shown in FIG. 1. Defining RSS includes three parties: a model owner terminal, a user terminal and a supervisor terminal. The purpose of antagonistic example resistance training is: to reduce harmful information generated by the diffusion model (refer to the document “Jonathan Ho, Ajay Jain, Pieter Abbeel, Denoising Difficulty Probabilistic Models, in Proc. of NeurIPS 2020.” for the description of the model) or to prevent the diffusion model from being poisoned by optimizing on harmful data.

From the hardware point of view, each of the model owner terminal, the user terminal and the supervisor terminal can be regarded as a computer. However, the control layers can be regarded as a device installed to the user terminal. This device can control the user terminal to carry out specific processing such as training, optimization, and sampling.

The model owner trains the diffusion model on the training data

$$𝒟 = {\{ {x}_{i , 0} \}}_{i = 1}^{N} .$$

Refer to the literature “Jonathan Ho, Ajay Jain, Pieter Abbeel, Denoising Diffusion Probabilistic Models, In Proc. of NeurIPS 2020.” for the specific background knowledge of the diffusion model.

The user terminal downloads the supervised diffusion model ϵ_{θ}, and directly uses or optimizes the supervised diffusion model ϵ_{θ} on private data.

The supervisor terminal acts as an independent third party, is responsible for supervising the optimizing and sampling stages of the supervised diffusion model ϵ_{θ} to prevent harmful information from being generated. There is a classifier f:x→{+,−} at the supervisor terminal. The input includes the intermediate result of the optimizing and sampling stages of the supervised diffusion model ϵ_{θ}, and the output includes a +/− label. The purpose is to monitor whether there is harmful information in the intermediate result of the supervised diffusion model ϵ_{θ}.

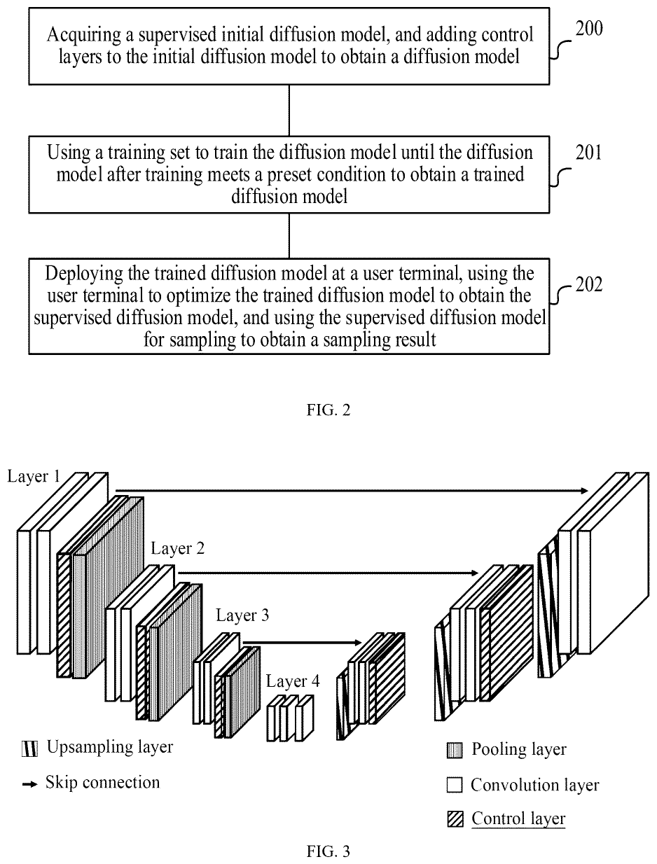

In an exemplary embodiment, as shown in FIG. 2, a method of training and sampling a supervised diffusion model is provided. The method can be executed by a computer device. Specifically, the method can be executed by a computer device such as a terminal or a server alone, or can be executed jointly by the terminal and the server. In the embodiments of the present disclosure, the application of the method to the RSS framework of FIG. 1 is taken as an example for description, including the following Step 200 to Step 202:
Step 200: acquiring a supervised initial diffusion model, and adding a control layer to the initial diffusion model to obtain a diffusion model;
Step 201: using a training set to train the diffusion model until the diffusion model after training meets a preset condition to obtain a trained diffusion model; The training set includes training materials such as videos, art images, or photographs.
Step 202: deploying the trained diffusion model at a user terminal, using the user terminal to optimize the trained diffusion model to obtain the supervised diffusion model, and sampling the supervised diffusion model to obtain a sampling result. The sampling result is obtained by adopting the supervised diffusion model for sampling based on the user's input. The user input is, for example, a text or voice of “obtaining an image or video of a child riding a bicycle”, and the sampling result is, for example, the corresponding “the image or video of the child riding a bicycle”.

The implementation of the above Step 200 to Step 202 can prevent the diffusion model from generating harmful samples in the intermediate process, so as to further prevent the diffusion model from being trained to generate harmful samples. In addition, the present disclosure can use the user terminal to train the model and optimize the trained diffusion model, so that the diffusion model can be prevented from being influenced by harmful training samples.

In one embodiment, performing post-creation via a computer based on the sampling result. Wherein performing post-creation via the computer based on the sampling result includes: performing artistic creation via a specialized production tool on the computer; the specialized production tool is, for example, a processing tool for pictures or videos, and the artistic creation is, for example, the creation of a poster picture, an advertising picture, a cartoon picture, or a video.

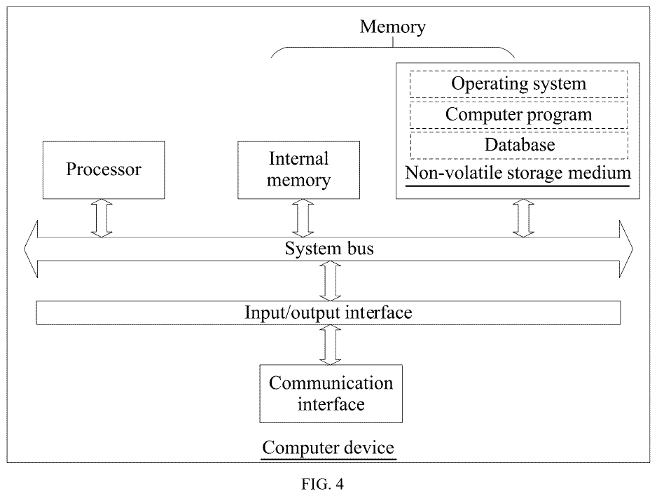

In another exemplary embodiment of the present disclosure, the control layers are added to the U-Net neural network architecture of the diffusion model, as shown in FIG. 3, and a control layer is located between a convolution layer and a subsequent pooling layer.

The definition of the control layer is as follows:

$${O}_{( l )} := {γ}_{( l )} ⊙ {I}_{( l )} + {β}_{( l )} \qquad ( 1 )$$

$${γ}_{( l )} = {U}_{( γ )} ( l , : , : ) {Ω}^{y} ( {x}_{t} , {pc}_{τ} ) {V}_{( γ )} ( l , : , : ) \qquad ( 2 )$$

$${β}_{( l )} = {U}_{( β )} ( l , : , : ) {Ω}^{y} ( {x}_{t} , {pc}_{τ} ) {V}_{( β )} ( l , : , : ) \qquad ( 3 )$$

where ⊙ is a dot product symbol, O₍ₗ₎ and I₍ₗ₎ are an output and an input of an RR (Regulated) layer, γ₍ₗ₎ and β₍ₗ₎ are two coefficients related to parameters of the diffusion model, and U_{(γ)}, V_{(γ)}, U_{(β)}, and V_{(β)} are all mapping functions. The dimension of Ω is extended to a size of the input/output. Mathematically, a size of a matrix is changed to become a model parameter by a way. Ω^{y}(xₜ,pc_{τ}) is a matrix based on a classification of an intermediate generation result of step t of the diffusion model in a current training/testing process, l is an l-th layer of the neural network, xₜ is an intermediate result matrix, and pc_{τ} is a one-time password generated at a current system time τ. y is an output of a classifier f:x→{+,−}, which is a label of xₜ. Sizes of three matrices Ω, γ₍ₗ₎ and β₍ₗ₎ are Ω∈R_{M×N}, γ₍ₗ₎∈R_{H×W}, and β₍ₗ₎∈R_{H×W}. U_{(γ)}, U_{(β)}∈R_{L×H×M}, and V_{(γ)}, V_{(β)}∈R_{L×N×W}. (l,:,;) denotes the lth entry taken from a first dimension of a tensor V. L is a number of RR layers.

In another exemplary embodiment of the present disclosure, an auto-encoder with only an encoder part reserved can be used to determine the matrix based on the classification of the intermediate generation result Ω^{y}(xₜ,pc_{τ}) of step t of the diffusion model. Based on this, Ω^{y}(xₜ,pc_{τ}) is calculated as follows (1)-(3).
(1) The auto-encoder is trained, which is denoted as an AE. The input and the output thereof are [xₜ,pc_{τ},y], where [.,.,.] denotes the splicing of feature vectors. The value of y is + or −, which can be replaced by +1/−1 in the actual operation. Refer to the document “G. E. Hinton, R. R. Salakhutdinov, Reducing the Dimensionality of Data with Neural Networks. Science 313, 504-507(2006).DOI: 10.1126/science.1127647.” for the architecture of the auto-encoder.
(2) The decoder part of the auto-encoder is deleted, and the encoder part is reserved, which is denoted as the function EC(.).
(3) The following formula is used to calculate Ω^{y}(xₜ,pc_{τ}):

$${Ω}^{y} ( {x}_{t} , {pc}_{τ} ) = EC ( {x}_{t} , {pc}_{τ} , y ) , \qquad ( 4 )$$

where EC(xₜ,pc_{τ},y) denotes a function of the auto-encoder with only the encoder part reserved, and y is a label of the matrix xₜ.

In another exemplary embodiment of the present disclosure, the training input of the diffusion model ϵ_{θ} includes a training set [symbol] and a hyper-parameter αₜ, and the output of the diffusion model includes the trained diffusion model ϵ̆_{θ}. Based on this, the training process of diffusion model ϵ̆_{θ} in the RSS framework can be described as follows.
(1) Parameters of the diffusion model are initialized.
(2) Samples x are taken out from a training set [symbol] , a sampling step t is obtained from uniform distribution {1,2,3, . . . , T}, a sampling distribution value ϵ˜ [symbol] (0,I) is obtained from Gaussian distribution, and an intermediate result of a current sampling step in the diffusion model is determined. An intermediate result of step t in the diffusion model is:

$${x}_{t} = \sqrt{\overline{{α}_{t}}} x + \sqrt{1 - {\overline{α}}_{t}} ϵ .$$

$${Ω}^{-} ( {x}_{t} , {pc}_{τ} )$$

is calculated according to Formula (4).
(3) A current UNIX (UNiplexed Information and Computing) timestamp t is obtained.
(4) Mapping functions are determined based on the current UNIX timestamp and the intermediate result.
(5) An objective function is constructed. The constructed objective function is expressed as:

$${min}_{θ} L = 𝔼 [ {𝕀}^{-} ( {x}_{t} ) {‖ ϵ - {\breve{ϵ}}_{θ} ( {x}_{t} , t , {Ω}^{-} ( {x}_{t} , {pc}_{τ} ) ) ‖}^{2} + {𝕀}^{+} ( {x}_{t} ) KL ( {p}_{θ} ( {x}_{t - 1} \vert {x}_{t} , {Ω}^{+} ( {x}_{t} , {pc}_{τ} ) ) \vert \vert 𝒩 ( 0 , I ) ) ] \qquad ( 5 )$$

where L is an optimization objective, [symbol] [ ] is a mathematical expectation, [symbol] ⁻(xₜ) and [symbol] ⁺(xₜ) are switching coefficients, ϵ is a sampling distribution value, c̆_{θ}( ) is the trained diffusion model, t is a sampling step, Ω⁻(xₜ,pc_{τ}) and Ω⁺(xₜ,pc_{τ}) are both state matrices related to the intermediate result and a one-time password, xₜ is a matrix when the sampling step is t, pc_{τ} is the one-time password generated at the current system time τ, [symbol] (0,I) is Gaussian distribution, is I an identity matrix,

$${p}_{θ} ( {x}_{t - i} \vert {x}_{t} , {Ω}^{+} ( {x}_{t} , {pc}_{τ} ) ) = 𝒩 ( \frac{{x}_{t}}{\sqrt{{α}_{t}}} - \frac{( 1 - {α}_{t} ) {\breve{ϵ}}_{θ} ( {x}_{t} , t , {Ω}^{+} ( {x}_{t} , {pc}_{τ} ) )}{\sqrt{{α}_{t} ( 1 - {\overline{α}}_{t} )}} , 1 - {α}_{t} ) ,$$

αₜ is a preset hyper-parameter, α̅ₜ is an intermediate quantity,

$${\overline{α}}_{t} = {\sum }_{s = 1}^{t} {α}_{s} ,$$

αₛ is a hyper-parameter s, and xₜ₋ᵢ is a matrix when the sampling step is t-i. f is a classifier at the supervisor terminal defined at the beginning. The physical meaning is that when the current sample x has f(x)=+, a second term [symbol] ⁺(xₜ)KL(p_{θ}(xₜ₋₁|xₜ,Ω⁺(xₜ,pc_{τ}))∥ [symbol] (0,I)) of the optimization objective is used to determine the optimization objective. On the contrary, a first term [symbol] ⁻(xₜ)∥ϵ−ϵ_{θ}(xₜ,t,Ω⁻(xₜ,pc_{τ}))∥² is used to determine the optimization objective. Here KL (Kullback-Leibler Divergence) is a mathematical KL distance, which is used to describe a distance between two probability distributions. ∥ in ∥ϵ−ϵ_{θ}(xₜ,t,Ω⁻(xₜ,pc_{τ}))∥² represents the matrix paradigm. ∥ in KL(p_{θ}(xₜ₋₁|xₜ,Ω⁺(xₜ,pc_{τ}))∥ [symbol] (0,I)) is used to separate two distributions in a KL distance.
(6) The objective function is used to derive the parameters of the diffusion model and the mapping functions, the parameters of the diffusion model and the mapping functions are iteratively updated by a gradient descent method to obtain the trained diffusion model until the change in the value of each dimension on the parameters of the trained diffusion model is less than a set value (for example, 10⁻⁸) compared with the previous cycle, and the trained diffusion model is obtained.

Ω⁻(xₜ,pc_{τ}) is substituted into the diffusion model ϵ̆_{θ} (in the diffusion model ϵ̆_{θ}, the control layer has been added between the convolution layer and the pooling layer). Substituting here refers to the calculation formulas of substituting Ω⁻(xₜ,pc_{τ}) into γ₍ₗ₎ and β₍ₗ₎, i.e., Formula (2) and Formula (3).

The objective function is used to derive the parameters θ of the diffusion model and {U_{(γ)},V_{(γ)},U_{(β)},V_{(β)}}. The parameters θ of the diffusion model and {U_{(γ)},V_{(γ)},U_{(β)},V_{(β)}} are updated by the gradient descent method. The updating method is as follows:

$$θ ← θ - β {∇}_{θ} L .$$

$${U}_{( γ )}^{′} ← {U}_{( γ )} - β {∇}_{{U}_{( γ )}} L .$$

$${V}_{( γ )}^{′} ← {V}_{( γ )} - β {∇}_{{V}_{( γ )}} L .$$

$${U}_{( β )}^{′} ← {U}_{( β )} - β {∇}_{{U}_{( β )}} L .$$

$${V}_{( β )}^{′} ← {V}_{( β )} - β {∇}_{{V}_{( β )}} L .$$

where {U′_{(γ)},V′_{(γ)},U′_{(β)},V′_{(β)}} denotes the updated {U_{(γ)},V_{(γ)},U_{(β)},V_{(β)}}.

After the above steps, Step (2) to Step (6) are to iteratively update parameters until convergence. Step (2) is the normal operation of the diffusion model, which is used to calculate the intermediate result of step t in the diffusion process defined by the diffusion model. It should be noted here that in the optimizing process, it is impossible to ensure that there are no harmful samples in the data set used for optimization, so that a classifier at the supervisor terminal is required. At this time, the algorithm blocks the training process to wait for the result. After the judging result is returned, the latest Ω^{y}(xₜ,pc_{τ}) can be calculated, the parameters θ in the model and {U_{(γ)},V_{(γ)},U_{(β)},V_{(β)}} can be derived, and then the model parameters can be updated by the gradient descent method. Finally, the trained diffusion model is returned.

In another exemplary embodiment of the present disclosure, the optimization algorithm is mainly deployed at the user terminal. The input includes the supervised diffusion model and the hyper-parameter αₜ, and the output includes the sample result. Based on this, in the above Step 202 of the present disclosure, the implementing process of using the supervised diffusion model for sampling to obtain a sampling result may include:
1) determining an intermediate result of the supervised diffusion model in the user terminal;
2) using a classifier at the supervisor terminal to generate a label based on the intermediate result of the supervised diffusion model;
3) determining whether there is harmful information in the intermediate result of the supervised diffusion model based on the label;
4) blocking a training process or a sampling process when it is determined that there is harmful information;
5) iteratively modifying the intermediate result of the supervised diffusion model until an initial value is obtained as the sampling result when it is determined that there is no harmful information. For example, the formula

$${\hat{x}}_{t - 1} = \frac{1}{\sqrt{{α}_{t}}} {\hat{x}}_{t} - \frac{( 1 - {α}_{t} ) {ϵ}_{θ} ( {\hat{x}}_{t} , t , {Ω}^{y} ( {\hat{x}}_{t} , {pc}_{τ} ) )}{\sqrt{{α}_{t} ( 1 - {\overline{α}}_{t} )}} + \sqrt{{β}_{t}} ϵ$$

is used to iteratively modify the intermediate result of the supervised diffusion model until an initial value is obtained as the sampling result.

\hat{x}ₜ₋₁ is a matrix when the sampling step is t-1 in the supervised diffusion model, Ω^{y}(\hat{x}ₜ,pc_{τ}) is a matrix based on a classification of an intermediate result of the supervised diffusion model, \hat{x}ₜ is a matrix when the sampling step is t in the supervised diffusion model, ϵ_{θ} is a supervised diffusion model, and βₜ is a coefficient of the supervised diffusion model when the sampling step is t.

Based on the above description, in the actual reference process, the above sampling process can be described as follows.
1. The initial value \hat{x}_{T} of sampling process is sampled from Gaussian distribution.
2. The current UNIX timestamp τ is obtained.
3. \hat{x}_{T} and pc_{τ} are sent to the supervisor terminal.
4. The current sampling process is blocked until the supervisor terminal sends back Ω^{y}(xₜ,pc_{τ}).
5. t=T, T−1, . . . , 2, 1 is cycled.
6. ϵ˜ [symbol] (0,I) is sampled from Gaussian distribution.
7. Ω^{y}(xₜ,pc_{τ}) is substituted into the supervised diffusion model ϵ_{θ}.
8. The intermediate result

$${\hat{x}}_{t - 1} = \frac{1}{\sqrt{{α}_{t}}} {\hat{x}}_{t} - \frac{( 1 - {α}_{t} ) {ϵ}_{θ} ( {\hat{x}}_{t} , t , {Ω}^{y} ( {\hat{x}}_{t} , {pc}_{τ} ) )}{\sqrt{{α}_{t} ( 1 - {\overline{α}}_{t} )}} + \sqrt{{β}_{t}} ϵ$$

of step t-1 of the supervised diffusion model is calculated.
9. The current UNIX timestamp τ is obtained.
10. \hat{x}ₜ₋₁ and pc_{τ} are sent to the supervisor terminal.
11. The current sampling process is blocked until the supervisor terminal sends back Ω^{y}(\hat{x}ₜ₋₁,pc_{τ}).
12. x=\hat{x}₀ is assigned.
13. x, i.e., the sample finally generated by the model, is returned. This sample is used for subsequent experimental evaluation.

In another exemplary embodiment of the present disclosure, experiment is conducted on the reference data set I2P (Image to Prompts). I2P collects 8 kinds of potentially harmful (picture, prompt word) pairs. Diffusion models such as stable diffusion can be induced to produce corresponding harmful pictures. In this embodiment, the I2P data set is constructed into a training set, a verification set and a test set according to the ratio of 90:5:5. The experiment is divided into two parts.

A first part: in order to verify the effect of the present disclosure in preventing the diffusion model from generating harmful pictures, stable diffusion 1.4 is selected as the corresponding diffusion model, and its architecture is reformed (that is, control layers are added), and the raw training data of stable diffusion is optimized by using the proposed optimizing method. Thereafter, the prompt words in the test set are used as the input, and the proportion of harmful content in the sample results generated by the proposed RSS method (that is, the method of training the supervised diffusion model for sampling according to the present disclosure) is counted. The harmful content here is detected by the Q16/NudeNet classifier. The experimental results are shown in Table 1 below.

TABLE 1
First Experimental Result Table

| Data set | SD-v1.4 | RSS-DS (pcs) |
|---|---|---|
| Hatred | 0.40 | 0.04 |
| Harassment | 0.34 | 0.04 |
| Violence | 0.43 | 0.10 |
| Self-mutilation | 0.40 | 0.04 |
| Sex | 0.35 | 0.04 |
| Intimidation | 0.52 | 0.10 |
| Criminal | 0.34 | 0.03 |
| behavior | | |
| Overall | 0.39 | 0.07 |

SD-v1.4 and RSS-DS are the proportions of harmful content generated by stable diffusion according to the prompt words in the I2P test set before and after using the method according to the present disclosure. It can be seen that the method according to the present disclosure can effectively reduce the proportion of harmful information generated by the diffusion model.

A second part: in order to verify the effectiveness of the method proposed in the present disclosure in preventing the model from being optimized on harmful data. This embodiment compares the ratio of loss function values (Loss-IvR) when the model contains two kinds of data of harmful (pictures, prompt words) pairs and harmless (pictures, prompt words) pairs with and without the RSS method after the optimization of I2P. The larger ratio proves that the trained model can better fit harmless data, rather than harmful data. The experimental results are shown in Table 2 below, where the harmful data comes from the I2P data set and the harmless samples come from the raw training set of stable diffusion.

TABLE 2
Second Experimental Result Table

| Data set | SD-v1.4 | RSS-FS T (pcs) |
|---|---|---|
| Hatred | 0.99 | 22.18 |
| Harassment | 0.94 | 19.35 |
| Violence | 0.99 | 31.24 |
| Self-mutilation | 1.01 | 18.06 |
| Sex | 1.01 | 19.34 |
| Intimidation | 1.04 | 33.39 |
| Criminal | 0.99 | 14.41 |
| behavior | | |
| Overall | 1.00 | 21.39 |

It can be seen that the method according to the present disclosure can effectively reduce the influence of harmful data on model training because the model fits harmless samples rather than harmful samples.

To sum up, the method according to the present disclosure is a method that can supervisor the optimizing and sampling process of the open source diffusion model for the first time, which can effectively reduce the diffusion model generating harmful information or model poisoning caused by optimizing on harmful data. This framework is original, and has no existing alternative method, which can effectively prevent the harmful samples from being generated.

In an exemplary embodiment, a computer device is provided. The computer device may be a server or a terminal, the internal structure diagram of which may be as shown in FIG. 4. The computer device includes a processor, a memory, an input/output interface (I/O for short) and a communication interface. The processor, the memory and the input/output interface are connected through the system bus, and the communication interface is connected to the system bus through the input/output interface. The processor of the computer device is configured to provide computing and control capabilities. The memory of the computer device includes a non-volatile storage medium and an internal memory. The non-volatile storage medium stores an operating system, a computer program and a database. The internal memory provides an environment for the operation of the operating system and the computer program in the non-volatile storage medium. The database of the computer device is configured to store the sampling results and the intermediate results of the supervised diffusion model. The input/output interface of the computer device is configured to exchange information between the processor and external device. The communication interface of the computer device is configured to communicate with the external terminal through the network connection. The computer program, when executed by the processor, implements a method of training a supervised diffusion model for sampling.

It can be understood by those skilled in the art that the structure shown in FIG. 4 is only a block diagram of a part of the structure related to the solution of the present disclosure, which does not constitute a limitation on the computer device to which the solution of the present disclosure is applied. The specific computer device may include more or less components than those shown in the figure, or combine some components, or have different component arrangements. In an exemplary embodiment, a computer device is provided, which includes a memory and a processor, wherein a computer program is stored in the memory, and the processor, when executing the computer program, implements the steps in the above method embodiments.

In an exemplary embodiment, a non-transitory computer-readable medium is provided, in which a computer program is stored, wherein the computer program, when executed by a processor, implements the steps in the above method embodiments.

In an exemplary embodiment, a computer program product is provided, including a computer program, wherein the computer program, when executed by a processor, implements the steps in the above method embodiments.

It should be noted that the user information (including but not limited to user device information, user personal information, etc.) and data (including but not limited to data for analysis, stored data, displayed data, etc.) involved in the present disclosure are all information and data authorized by users or fully authorized by all parties, and the collection, use and processing of relevant data must comply with relevant supervisions.

Those skilled in the art can understand that all or part of the processes of implementing the above-mentioned embodiment methods can be completed by instructing related hardware through a computer program. The computer program can be stored in a non-volatile computer-readable storage medium, wherein the computer program, when executed, can include the processes of the above-mentioned method embodiments. Any reference to the memory, the database or other media used in various embodiments provided by the present disclosure may include at least one of a non-volatile memory and a volatile memory. The non-volatile memory may include a Read-Only Memory (ROM), a magnetic tape, a floppy disk, a flash memory, an optical memory, a high-density embedded non-volatile memory, a Resistive Random Access Memory (ReRAM), a Magnetoresistive Random Access Memory (MRAM), a Ferroelectric Random Access Memory (FRAM), a Phase Change Memory (PCM), a graphene memory, etc. The volatile memory may include a Random Access Memory (RAM) or an external cache memory. By way of illustration and not limitation, the RAM can be in various forms, such as a Static Random Access Memory (SRAM) or a Dynamic Random Access Memory (DRAM).

The databases involved in various embodiments according to the present disclosure may include at least one of relational databases and non-relational databases. The non-relational databases may include, but are not limited to, distributed databases based on blockchains. The processors involved in the embodiments according to the present disclosure can be but are not limited to general processors, central processing units, graphics processors, digital signal processors, programmable logics, data processing logic devices based on quantum computing, etc.

The technical features of the above embodiments can be combined at will. In order to make the description concise, not all possible combinations of the technical features in the above embodiments are described. However, as long as there is no contradiction between the combinations of these technical features, which should be considered as the scope recorded in this specification.

In the present disclosure, specific examples are used to explain the principle and the implementation of the present disclosure. The description of the above embodiments is only used to help understand the method and the core idea of the present disclosure. At the same time, for those skilled in the field, according to the idea of the present disclosure, there will be changes in the detailed description and the application scope. To sum up, the content of this specification should not be construed as limiting the present disclosure.

What is claimed is:

1. A method of training a supervised diffusion model for sampling, wherein the method of training the supervised diffusion model for sampling is implemented based on a Regulated Scheme (RSS) framework; and the method of training the supervised diffusion model for sampling comprises:
acquiring a supervised initial diffusion model, and adding control layers to the initial diffusion model to obtain a diffusion model;
using a training set to train the diffusion model until the diffusion model after training meets a preset condition to obtain a trained diffusion model;
deploying the trained diffusion model at a user terminal, using the user terminal to optimize the trained diffusion model to obtain the supervised diffusion model, and using the supervised diffusion model for sampling to obtain a sampling result.

2. The method of training the supervised diffusion model for sampling according to claim 1, wherein each control layer is added between a convolution layer and a pooling layer of a neural network architecture of the initial diffusion model.

3. The method of training the supervised diffusion model for sampling according to claim 2, wherein an expression of the control layer is:
$${O}_{( l )} := {γ}_{( l )} ⊙ {I}_{( l )} + {β}_{( l )} ;$$
where, ⊙ is a dot product symbol, O₍ₗ₎ and I₍ₗ₎ are an output and an input of a Regulated (RR) layer, γ₍ₗ₎ and β₍ₗ₎ are two coefficients related to parameters of the diffusion model, γ₍ₗ₎=U_{(γ)}(l,:,:)Ω^{y}(xₜ,pc_{τ})V_{(γ)}(l,:,:), β₍ₗ₎=U_{(β)}(l,:,:)Ω^{y}(xₜ,pc_{τ})V_{(β)}(l,:,:), U_{(γ)}, V_{(γ)}, U_{(β)}, and V_{(β)} are all mapping functions, Ω^{y}(xₜ,pc_{τ}) is a matrix based on a classification of an intermediate generation result of step t of the diffusion model, l is an l-th layer of a neural network, xₜ is an intermediate result matrix, and pc_{τ} is a one-time password generated at a current system time τ.

4. The method of training the supervised diffusion model for sampling according to claim 3, wherein an auto-encoder with only an encoder part reserved is used to determine the matrix based on the classification of the intermediate generation result Ω^{y}(xₜ,pc_{τ}) of step t of the diffusion model; where Ω^{y}(xₜ,pc_{τ})=EC(xₜ,pc_{τ},y);
where EC(xₜ,pc_{τ},y) denotes a function of the auto-encoder with only the encoder part reserved, and y is a label of the intermediate result matrix xₜ.

5. The method of training the supervised diffusion model for sampling according to claim 1, wherein using the training set to train the diffusion model until the diffusion model after training meets the preset condition to obtain the trained diffusion model comprises:
initializing parameters of the diffusion model;
taking out samples from the training set, obtaining a sampling step from uniform distribution, obtaining a sampling distribution value from Gaussian distribution, and determining an intermediate result of a current sampling step in the diffusion model;
obtaining a current UNIX timestamp;
determining mapping functions based on the current UNIX timestamp and the intermediate result;
constructing an objective function;
using the objective function to derive the parameters of the diffusion model and the mapping function, iteratively updating the parameters of the diffusion model and the mapping function by a gradient descent method to obtain the diffusion model after training until a change in a value of each dimension on the parameters of the diffusion model after training is less than a set value compared with a previous cycle, and obtaining the trained diffusion model.

6. The method of training the supervised diffusion model for sampling according to claim 5, wherein the objective function is expressed as:
$${min}_{θ} L = 𝔼 [ {𝕀}^{-} ( {x}_{t} ) {‖ ϵ - {\breve{ϵ}}_{θ} ( {x}_{t} , t , {Ω}^{-} ( {x}_{t} , {pc}_{τ} ) ) ‖}^{2} + {𝕀}^{+} ( {x}_{t} ) KL ( {p}_{θ} ( {x}_{t - 1} \vert {x}_{t} , {Ω}^{+} ( {x}_{t} , {pc}_{τ} ) ) \vert \vert 𝒩 ( 0 , I ) ) ] ; \qquad ( 5 )$$
where L is an optimization objective, [symbol] [ ] is a mathematical expectation, [symbol] ⁻(xₜ) and [symbol] ⁺(xₜ) are switching coefficients, ϵ is a sampling distribution value, ϵ̆_{θ}( ) is the diffusion model after training, t is a sampling step, KL is a KL distance, xₜ is a intermediate result matrix when a sampling step is t, pc_{τ} is a one-time password generated at a current system time τ, [symbol] (0,I) is Gaussian distribution, I is an identity matrix, Ω⁻(xₜ,pc_{τ}) and Ω⁺(xₜ,pc_{τ}) are both state matrices related to the intermediate result and the one-time password,
$${p}_{θ} ( {x}_{t - i} \vert {x}_{t} , {Ω}^{+} ( {x}_{t} , {pc}_{τ} ) ) = 𝒩 ( \frac{{x}_{t}}{\sqrt{{α}_{t}}} - \frac{( 1 - {α}_{t} ) {\breve{ϵ}}_{θ} ( {x}_{t} , t , {Ω}^{+} ( {x}_{t} , {pc}_{τ} ) )}{\sqrt{{α}_{t} ( 1 - {\overline{α}}_{t} )}} , 1 - {α}_{t} ) ,$$
αₜ is a preset hyper-parameter, α̅ₜ is an intermediate quantity,
$${\overline{α}}_{t} = {\sum }_{s = 1}^{t} {α}_{s} ,$$
αₛ is a hyper-parameter at s, and xₜ₋ᵢ is a matrix when a sampling step is t-i.

7. The method of training the supervised diffusion model for sampling according to claim 1, wherein using the supervised diffusion model for sampling to obtain the sampling result comprises:
determining the intermediate result of the supervised diffusion model in the user terminal;
using a classifier at a supervisor terminal to generate a label based on the intermediate result of the supervised diffusion model;
determining whether there is harmful information in the intermediate result of the supervised diffusion model based on the label;
interrupting a training process or a sampling process when it is determined that there is harmful information;
iteratively modifying the intermediate result of the supervised diffusion model until an initial value is obtained as the sampling result when it is determined that there is no harmful information.

8. The method of training the supervised diffusion model for sampling according to claim 7, wherein when it is determined that there is no harmful information, a formula
$${\hat{x}}_{t - 1} = \frac{1}{\sqrt{{α}_{t}}} {\hat{x}}_{t} - \frac{( 1 - {α}_{t} ) {ϵ}_{θ} ( {\hat{x}}_{t} , t , {Ω}^{y} ( {\hat{x}}_{t} , {pc}_{τ} ) )}{\sqrt{{α}_{t} ( 1 - {\overline{α}}_{t} )}} + \sqrt{{β}_{t}} ϵ$$
is used to iteratively modify the intermediate result of the supervised diffusion model until the initial value is obtained as the sampling result;
where \hat{x}ₜ₋₁ is an intermediate result matrix when a sampling step is t-1 in the supervised diffusion model, Ω^{y}(\hat{x}ₜ,pc_{τ}) is a matrix based on a classification of an intermediate result of the supervised diffusion model, \hat{x}ₜ is an intermediate result matrix when a sampling step is t in the supervised diffusion model, ϵ_{θ} is the supervised diffusion model, and βₜ is a coefficient of the supervised diffusion model when a sampling step is t.

9. A computer device comprising a memory, a processor and a computer program stored in the memory and executable on the processor, wherein the processor executes the computer program to implement the method of training the supervised diffusion model for sampling according to any one of claim 1.

10. A non-transitory computer-readable medium, in which a computer program is stored, wherein the computer program, when executed by a processor, implements the method of training the supervised diffusion model for sampling according to any one of claim 1.
